(19) United States
(12) Patent Application Publication
(10) Pub. No.: US 2009/0268355 A1
(43) Pub. Date: Oct. 29, 2009

(54) SAFETY OUTPUT DEVICE FOR USE IN A POWER CONVERTER AND POWER CONVERTER PROVIDED WITH THE SAME

(75) Inventor: Percy Wang, Taipei (TW)

Correspondence Address: Yen Jung Sung, 21-80 38 St, #C8, Astoria, NY, 11105, US

(73) Assignee: Kerio Technologies, Inc, Taipei (TW)

(21) Appl. No.: 12/257,393

(22) Filed: Oct. 24, 2008

(30) Foreign Application Priority Data
Apr. 23, 2008 (TW) 097127885

(51) Int. Cl. H02H 9/02

(52) U.S. Cl. 361/18

(57) ABSTRACT

The present invention relates to a safety output device for use in a power converter that includes a converter main body adapted for outputting a direct-current electric power at a predetermined voltage. The safety output device is adapted for being associated with an electricity consuming device that is powered by the power converter and comprises a wire set adapted for being electrically connected to the converter main body, a sensing controller for measuring a voltage difference in the wire set, and a switch adapted for being actuated by the sensing controller to permit electric conduction from the converter main body to the electricity consuming device when the voltage difference is detected to be substantially equal to the predetermined voltage.

### FIELD OF THE INVENTION

The present invention relates to a safety output device, and more particularly, to a safety output device for use in a power converter.

### DESCRIPTION OF THE RELATED ART

The electronic circuits present in many of the electronic appliances pertain to the digital circuits that are designed to consume direct-current low voltage electricity. However, the electric power supplied by a power plant is normally in the form of alternating current with a much higher voltage. As such, voltage conversion must be carried out before the electric power is supplied to the electronic appliances from a wall socket. As portability becomes a growing trend in electronic products, it is no longer practicable to build a converter in the miniaturized portable electronics. It makes a wide variety of converters become indispensable in modern life and almost all types of the major electronic appliances such as portable audio/video players, mobile phones, MP3 and laptop computers are accompanied with converters of their own.

Due to commercial consideration, converters provided by different manufacturers have their own individual specifications and may vary in output voltage, adapter size and so on, whereas the standard household voltage may also vary from country to country. Although efforts have been made by manufacturers to make converters tolerable to the ordinary incoming voltage ranging from 110 volts to 220 volts and capable of converting the incoming voltage into a particular outgoing voltage, the magnitude of the outgoing voltages and the size of adapters remain to be standardized.

Because of the diversity of electronic appliances, each family or even each user must possess a large number of converters of various specifications, which would turn out to be burdensome once the electronic products to which the converters are connected are out of order. In response to consumer demands, converters that provide variable output voltages and have changeable adapters are now available in the market, which would significantly reduce the number of converters that one should have at home and further ease the inconvenience of carrying different types of converters during leisure or business travel.

However, as shown in FIG. 1, a conventional power converter 12 is configured to adjust the output voltage by providing a slide switch 14 that is associated with the output wire and changing the resistance of the resistor mounted in the slide switch 14 to thereby operatively change the voltage level of the electric power that is to be output via the output terminal 13. Unfortunately, the actuator 15 of the switch 14 in this configuration will get loose gradually after a long time use and, therefore, the output voltage will become unstable due to the occurrence of miscontact. Accidental miscontact that occurs during the operation of the switch 14 can be a serious risk for personal safety and performance of electronic products.

On the other hand, in considering the cost effectiveness and portability, manufacturers of portable electronic products normally build safety circuits in the converters that are exclusively useful for their own products, while asking consumers not to use converters of other types. Generally, the laptop computers available in the market are manufactured to tolerate a 5% plus/minus variation in the ideal voltage level. In other words, damage would occur to the intrinsic circuits of the laptop computers if the incoming voltage goes beyond the predicted range. In the case where the original parts are either missing or not on hand, a user may have to acquire a non-original converter from the market, which may not have a circuit design for monitoring the output voltage and enabling an alarm in response to detection of the occurrence of an output fault. Even if the non-original converter is equipped with a monitoring device in the voltage-transforming circuit, the user may still have to face a risk of abrupt output voltage fluctuation caused by a structural defect between the monitoring device and the output port due to inferior quality control.

Therefore, there exists a need for a miniature safety output device that is cost-effective as compared to the portable electronic appliances to which it may be connected and is capable of ensuring that the electric output from any type of power converters is at a level demanded by the specifications of the portable electronic appliances to which it may be connected. The present invention provides the best solution in response to the need.

### SUMMARY OF THE INVENTION

Accordingly, an object of the present invention is to provide a safety output device for use in a power converter, which is extremely safe as it will decline to transmit electric power at an undesired voltage level.

Another object of the invention is to provide a safety output device for use in a power converter, which has a simple and compact structure that will not adversely affect the portability of the electronic appliances to which it is connected.

It is still another object of the invention to provide a safety output device for use in a power converter, which has the advantage of low manufacture cost.

It is still another object of the invention to provide a safety output device for use in a power converter, which is capable of continuously monitoring the voltage/current output from the power converter and cutting off the power supply to an electronic appliance in response to detection of the occurrence of an output fault, thereby ensuring that damage will not occur to the electronic device as a result of the output fault.

It is still another object of the invention to provide a power converter having a safety output device mounted therein, which is extremely safe as it will prevent damage to the electronic appliances to which it is connected.

The present invention therefore provides a safety output device for use in a power converter, where said power converter has a converter main body adapted for outputting a direct current electric power at a predetermined voltage and where said safety output device is adapted for being electrically connected to an electricity consuming device that is powered by the power converter, the safety output device comprising: a wire set adapted for being electrically connected to the converter main body, including a high level wire and a low level wire that are configured to receive the electric power from the converter main body; a sensing controller for measuring a voltage difference between the high level wire and the low level wire; and a switch adapted for being actuated by the sensing controller to permit electric conduction from the converter main body to the electricity consuming device when the voltage difference between the high level wire and the low level wire is substantially equal to the predetermined direct current voltage.

In the context of the invention, the term “electrically connected to” is defined as a condition where two or more components are electrically communicated to enable the flow of electrical current, either by way of direct coupling or through one or more intermediate components such as an adaptor, an electrical wire or the like.

The invention allows users to readily choose an appropriate safety output device that is well compatible with the electronic appliance to which it is to be connected, by reference to the voltage and current specifications of the electronic appliance provided by the manufacturer, and connect the same to a charging port of the electronic appliance. If the incoming voltage from the power converter is at an undesired level, the safety output device will decline to transmit electric power to the electronic appliance, so that a good quality of power supply can be obtained. In particular, the safety output device according to the invention may be configured to continuously monitoring the quality of power supply, so as to ensure the safety of using electrical equipments. The safety output device according to the invention further presents advantages of simple circuit design, low manufacture cost and compact size, so that the portability and performance of electronic devices are not adversely affected by the weight and size of the safety output device. The invention enables users to acquire appropriate safety output devices for the precious electronic appliances of their own and utilize the same in conjunction with any types of converters available in the market without worrying about any damage that may otherwise occur to their electronic appliances.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a perspective view of a conventional power converter;

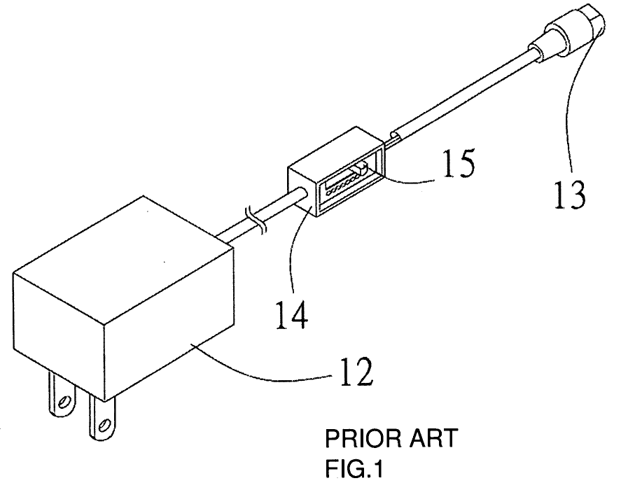

FIG. 2 is a perspective view of a power converter according to the first preferred embodiment of the invention, illustrating the technical relationship among a safety output device, a converter main body and an electronic appliance;

FIG. 3 is a circuit diagram for the converter main body shown in FIG. 2;

FIG. 4 is a circuit diagram for the safety output device shown in FIG. 2; and

FIG. 5 is a bock diagram illustrating a power converter according to the second preferred embodiment of the invention.

FIG. 6 is a schematic diagram outlining the structure of the second preferred embodiment of the invention.

### DETAILED DESCRIPTION OF THE INVENTION

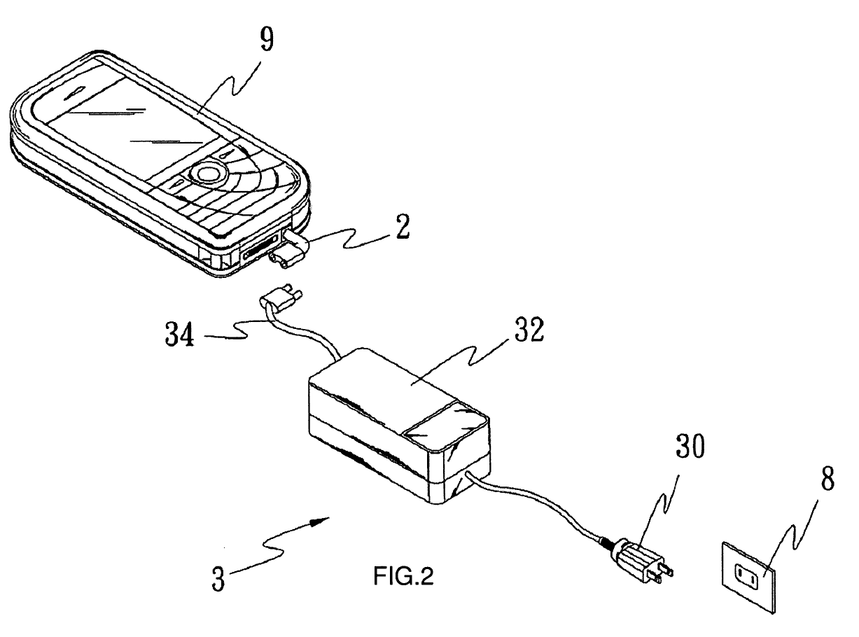

FIG. 2 is a schematic diagram of a power converter, as well as a safety output device provided therein, according to the first preferred embodiment of the invention. In this embodiment, the power converter may by way of example be connected to a wall socket 8 and therefore receives an incoming voltage of 110 volts. The electronic appliance that is to be powered by the power converter is hereafter referred to as an electricity consuming device. For the sake of elucidation, the electricity consuming device according to this embodiment may by way of example be a mobile phone 9 that is designed to receive a charging voltage of 5 volts DC. Of course, it would be appreciated by those skilled in the art that the incoming voltage mentioned above can be either 220 volts AC or 12 volts DC supplied by an automobile power supply, and that the electricity consuming device may pertain to any type of electronic appliances.

As an abnormally large value of the charging voltage may cause the lithium battery used in the mobile phone 9 to overheat or even catch fire, the voltage given to the mobile phone 9 should not exceed the required level. In this embodiment, the safety output device is configured in the form of an adapter that is compatible with and pluggable into a charging port of the mobile phone 9.

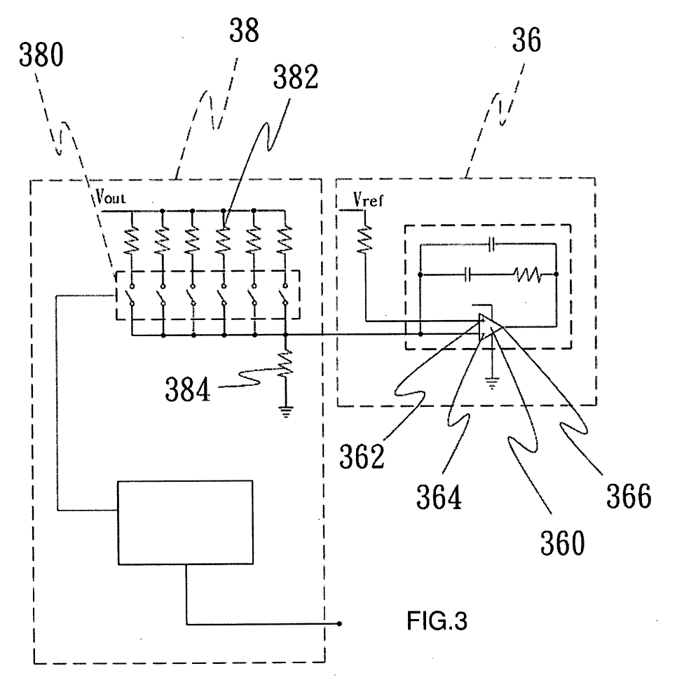

The power converter according to this embodiment comprises a safety output device 2 and a converter main body 3. The converter main body 3 according to this embodiment includes a plug 30 that serves as an input port adapted for being electrically connected to the wall socket 8, an output wire 34 that serves as an output port, and a housing 32 coupled between the plug 30 and the output wire 34, wherein the housing 32 accommodates a voltage-transforming unit 36 and a voltage-selecting unit 38, as shown in FIG. 3. The voltage-transforming unit 36 is provided with a voltage-transforming circuitry in which, for example, a feedback control amplifier 360 is provided to allow feeding of a reference voltage Vref to a non-inverting input terminal 362, and an inverting input terminal 364 is connected to an output terminal 366 to thereby follow the reference voltage Vref. The inverting input terminal 364 can be selectively connected to one of a plurality of circuits arranged within a switch 380 that serves as the voltage-selecting unit 38. Each circuit is provided with a resistor 382 with the respective resistors 382 having different resistances from one another.

When a resistor 382 of a certain resistance is connected to ground by the switch, the resistance ratio of the two resistors 382 and 384 will determine the voltage at the output terminal Vout, as the voltage at the inverting input terminal 364 is correlated with the reference voltage Vref at the non- inverting input terminal 362. In the case where the resistor 382 connected to the amplifier is switched from one to the other, the resistance ratio of resistors 382 and 384 is changed and, as a result, the output voltage Vout is changed accordingly. Of course, it would be appreciated by those skilled in the art that the power converter according to the invention is not limited to those providing variable output voltages but also includes those which convert an input voltage into a fixed output voltage. For the preferred circuitries for providing variable output voltages, please refer to R.O.C. Patent Application No. 97106821 assigned to the applicant.

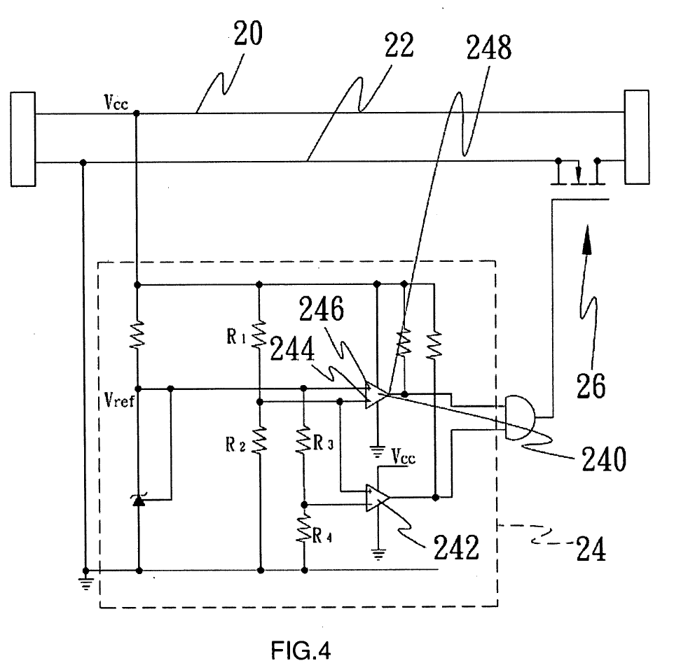

As shown in FIG. 4, the safety output device according to the invention has a wire set including a high level wire 20 and a low level wire 22 that are electrically connected to separate output terminals of the converter main body. In this embodiment, the potential of the low level wire 22 is defined to be zero, so that the low level wire is connected to ground as shown in the Figure. However, it would be appreciated by those skilled in the art that such an aspect should be regarded as illustrative in nature and not as restrictive. In this embodiment, the low level wire 22 is provided with a switch, which may by way of example be a metal-oxide-semiconductor field-effect transistor (MOSFET) 26 having a gate electrode connected to a voltage difference sensing controller 24 that acts as a control unit for controlling the electrical conduction between the drain and source of MOSFET 26.

In this embodiment, the voltage difference sensing controller 24 is provided with two comparators 240 and 242. When a reference voltage Vref is fed to the non-inverting input terminal 246 of the comparator 240, the potential at the inverting input terminal 244, namely,

$$\frac{R 2}{R 1 + R 2} Vcc ,$$

is determined by the resistance ratio between the resistors R1 and R2. As such, if the value of

$$\frac{R 2}{R 1 + R 2} Vcc$$

is higher than Vref, the output terminal 248 of the comparator 240 will output high level signals, thereby placing the gate of MOSFET 26 in an electrical conduction state. On the contrary, if the value of

$$\frac{R 2}{R 1 + R 2} Vcc$$

is lower than Vref, representing a condition where the potential of the high level wire 20 is so high as to exceed the limit value defined by the reference voltage, the output terminal 248 of the comparator 240 will output low level signals, whereby a downstream AND gate maintains the disconnection of the source and drain of MOSFET 26 to protect the electricity consuming device from over-voltage damage.

Meanwhile, the comparator 242 utilizes the potential at the inverting input terminal, namely,

$$\frac{R 4}{R 3 + R 4} Vref ,$$

as the reference. If the potential at the non-inverting input terminal, namely,

$$\frac{R 2}{R 1 + R 2} Vcc ,$$

is higher than

$$\frac{R 4}{R 3 + R 4} Vref ,$$

the output terminal of the comparator 242 will output high level signals to confirm that the potential of the high level wire 20 exceeds the predetermined lower limit

$$\frac{R 4}{R 3 + R 4} Vref .$$

On the contrary, if the potential of the high level wire 20 is too low, the comparator 242 will output low level signals, whereby a downstream AND gate maintains the disconnection of the source and drain of MOSFET 26 to protect the electricity consuming device from under-voltage damage.

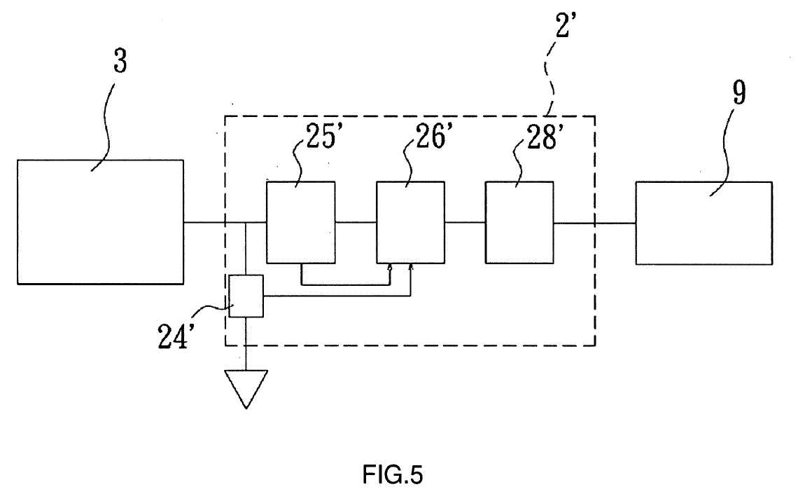

The invention further provides a second preferred embodiment as illustrated in FIG. 5, which differs from the first preferred embodiment in that the sensing controller further comprises a current-sensing controller 25′ connected in series with the wire set to thereby detect the current level of the wire set. In addition to monitoring the voltage difference between the two wires in the wire set by virtue of a voltage difference sensing controller 24′ to thereby prevent damage to the electricity consuming device caused by a non-ideal voltage, the safety output device according to the invention is preferably configured to turn off the switch 26′ immediately using the current-sensing controller mentioned above, in response to the event that the current level of the wire set exceeds a predetermined level due to the occurrence of an internal short circuit fault in the electricity consuming device, whereby damage to the electricity consuming device is further reduced.

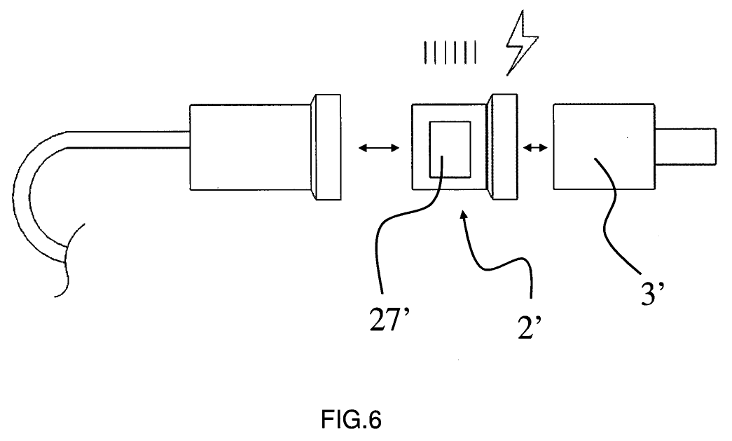

Of course, it would be appreciated by those skilled in the art that the safety output device according to the invention is not limited to those formed of a single-part configuration and adapted for directly coupling to an electronic appliance. In response to the fact that the charging ports of portable electronics, including laptop computers and personal digital assistants, are constructed by different manufacturers with widely diverse dimensions, the safety output device 2′ according to the second preferred embodiment of the invention, as shown in FIG. 6, is provided with an adapter 3′ that is configured to match with the charging port of the electronic appliance to which it is to be coupled. Only the adapter 3′ has to be manufactured with various specifications particularly suited for coupling to the charging ports of the electronic appliances. The safety output device 2′ itself is of a universal specification and, as a result, the manufacture cost thereof is significantly reduced.

The safety output device 2′ according to this embodiment may be further provided with an LED 27′ which is electrically connected to the voltage difference sensing controller 24′ in such a manner that when the voltage difference detected by the voltage difference sensing controller 24′ deviates from a predetermined value beyond a predetermined deviation, the LED 27′ flashes to indicate the occurrence of an output fault while the downstream switch 26′ is kept in the OFF state.

To improve the quality of power supply to the greatest extent possible, the safety output device according to the invention is optionally provided with a voltage stabilizing circuit 28′ to thereby provide stable electricity to the downstream electronic appliances. Of course, all of the electronic circuits mentioned above can be incorporated in a single integrated circuit according to the modern technology, instead of being fabricated as discrete components.

Accordingly, the invention enables a user to protect any electronic appliance from over-voltage damage by acquiring a suitable safety output device according to the invention and mounting the same to a charging port of the appliance. The safety output device according to the invention does not only ensure that the voltage received by the appliance is kept in an ideal range, but also prevents over-current damage by selectively cutting out the power supply. The safety output device according to the invention may further be provided with a voltage stabilizing circuit to improve the stability of the powder supply to the appliance. In particular, the safety output device according to the invention presents advantages of low manufacture cost and compact size, so that the portability and performance of the appliance are not adversely affected by the weight and size of the safety output device. The safety output device according to the invention enables a user to utilize any types of converters available in the market without worrying about any damage that may occur to the appliance.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A safety output device for use in a power converter, where said power converter has a converter main body adapted for outputting a direct-current electric power at a predetermined voltage and where said safety output device is adapted for being electrically connected to an electricity consuming device that is powered by the power converter, the safety output device comprising:
a wire set adapted for being electrically connected to the converter main body, including a high level wire and a low level wire that are configured to receive the electric power from the converter main body;
a sensing controller for measuring a voltage difference between the high level wire and the low level wire; and
a switch adapted for being actuated by the sensing controller to permit electric conduction from the converter main body to the electricity consuming device when the voltage difference between the high level wire and the low level wire is substantially equal to the predetermined direct-current voltage.

2. The safety output device according to claim 1, wherein the sensing controller further comprises a current-sensing controller for monitoring the current level of the wire set and, if the current level of the wire set exceeds a predetermined level, terminating the electric conduction permitted by the switch.

3. The safety output device according to claim 1, further comprising a voltage stabilizing circuit associated with the wire set.

4. The safety output device according to claim 3, wherein the sensing controller further comprises a current-sensing controller for monitoring the current level of the wire set and, if the current level of the wire set exceeds a predetermined level, terminating the electric conduction permitted by the switch.

5. The safety output device according to claim 1, further comprising an alert element which is electrically connected to the voltage difference sensing controller in such a manner that the alert element generates a warning signal when the voltage difference between the high level wire and the low level wire substantially deviates from the predetermined direct-current voltage.

6. A power converter having a safety output device mounted therein and adapted for powering an electricity consuming device, comprising:
a converter main body including an input port, an output port and a voltage transforming unit for converting an input voltage fed to the input port into an output voltage that is to be output via the output port; and
a safety output device adapted for being electrically connected to the electricity consuming device, the safety output device comprising:
a wire set adapted for being electrically connected to the converter main body, including a high level wire and a low level wire that are configured to receive the electric power from the converter main body;
a sensing controller for measuring a voltage difference between the high level wire and the low level wire; and
a switch adapted for being actuated by the sensing controller to permit electric conduction from the converter main body to the electricity consuming device when the voltage difference between the high level wire and the low level wire is substantially equal to the output voltage.

7. The power converter according to claim 5, wherein said converter main body further comprises a plurality of distinct circuits and a voltage-selecting unit configured to selectively place one circuit out of the plurality of distinct circuits in an electrical conduction state, thereby enabling the conversion of the input voltage fed to the input port into one of a plurality of distinct output voltages that is to be output via the output port.
